(19) United States
(12) Patent Application Publication
(10) Pub. No.: US 2012/0204215 A1
(43) Pub. Date: Aug. 9, 2012

(54) DIGITAL VIDEO RECORDER (DVR) METHODS AND APPARATUS

(76) Inventors: Michael T. Hayashi, Evergreen, CO (US); Kenneth Gould, Reston, VA (US)

(21) Appl. No.: 13/023,330

(22) Filed: Feb. 8, 2011

(51) Int. Cl. H04N 7/173

(52) U.S. Cl. 725/88

(57) ABSTRACT

Digital video recorder (DVR) methods and apparatus are described. By combining DVR and on-demand functionality a large number of programs selected by a user can be made available to the DVR user and may be included in a single content availability list. The list may indicate whether the recording is available via an on-demand service or is locally recorded/stored content. When the user selects content for recording a check is automatically made to determine if the content is available via an on-demand server. If the content is available via an on-demand server the user is provided the opportunity to choose between the content being recorded by the DVR or being added to the recordings list but supplied via the on-demand server. In some embodiments the user may select the DVR to default to on-demand content supply as opposed to local recording when the content is available for on-demand delivery.

### FIELD OF THE INVENTION

The present invention relates to digital video recorder methods and apparatus, and more particularly, to methods and apparatus for combining DVR and on-demand functionality in a manner that reduces the need for storage space in a DVR to make a large amount of content available to a user.

### BACKGROUND OF THE INVENTION

Many set top boxes now support digital video recorder (DVR) functionality. The amount of content which can be recorded by a user is normally limited by the amount of storage space, e.g., disk space, included in the DVR being used.

While DVR functionality has made it easier for users to record and watch programs, the cost of supplying DVRs to customers can be considerable. In addition, the cost of upgrading or replacing DVRs to increase their storage capacity in response to user's expectations that they should be able to record ever greater amounts of content can present a considerable cost burden to cable and other companies who provide DVRs on a rental or subscription service basis.

In addition to the broadcasting of content according to a schedule, cable companies and other content providers have been increasingly supporting content on-demand, e.g., video on-demand, to an ever larger degree.

While some broadcast content may be available via an on-demand service, some broadcast content may not be available on-demand or may be available for only a limited time period. In cases where content is available on-demand for a limited time period, a user may not want to view the content during its limited availability but would like to have it available for viewing outside the limited availability period.

For a variety of reasons, DVR use remains common place even as cable and other suppliers of content expand their VOD content libraries and the number of users to which they can simultaneously stream content.

Over time users tend to fill up their DVR storage space. This leads to users wanting DVRs with ever more recording capacity. In the case where DVRs are purchased by the user, the cost of buying a new DVR may discourage frequent upgrades and/or DVR replacement. However, in the case of rented DVRs, such as those which are provided as part of a cable TV service or other package, a user may feel that they should be provided with a new DVR with increased recording capacity simply because other, more recent subscriber's, are being given new DVRs with greater recording capacity.

In view of the above discussion, it should be appreciated that there is a need for methods and apparatus which could provide users of DVRs access to greater amounts of content without having to increase the size of the storage capacity of their DVRs. It would be desirable if at least some of the methods could be implemented in which a user could be sure they will have access to content they selected for recording beyond a limited period of VOD availability and/or without the user having to separately determine if content selected for recording was available via a content on-demand, e.g., video on-demand (VOD), service.

### SUMMARY

Methods and apparatus for enhancing digital video recorder (DVR) functionally through the use of content delivery on-demand are described. By combining DVR functionality with a content on-demand service, a DVR user is provided access to a large amount of content in a manner that is relatively transparent to the DVR user. Thus, by combining on-demand and DVR functionality, a user can have access to a larger amount of content than can be recorded on the user's limited DVR recording space.

In at least some exemplary embodiments, when a user selects content to be recorded, e.g., from a broadcast schedule such as a conventional broadcast program guide, a determination is automatically made as to whether the content selected for recording is available via an on-demand service.

For purposes of determining content availability via an on-demand service, currently available content is considered as well as content which will be available on or before the scheduled recording time. This is because, from the perspective of the user of the DVR, the on-demand content maybe considered a viable alternative to recording the selected broadcast content if it is available prior to or at the user selected recording time. VOD availability may be determined to be at the same recording time, if the VOD availability time and the selected recording time are within some predetermined range of each other. For example, in some systems VOD content is determined to be available at the same time as a selected recording time if the VOD content availability is, within one, two or three minutes of the selected recording time depending on the particular embodiment. Thus, in at least some embodiments content which is made available for VOD delivery within a minute of its broadcast would be considered to be available at the same time as the broadcast content in at least some embodiments. Such an approach takes into consideration that for live broadcasts, there may be a delay of several seconds between the live broadcast and the VOD availability of the broadcast.

The determination of whether or not content selected for recording is available via an on-demand service may be made in variety of ways. In embodiments where the user's DVR has limited upstream capability, a locally stored on-demand content availability list is checked to determine if the content selected for recording is available via the VOD service. The list may be obtained and stored from a broadcast of the VOD availability information by a broadcast file server which is received by the set top box/DVR. Such an embodiment is particularly well suited for cases where a DVR has relatively limited bandwidth to send requests for information to other devices. This is common in cases where a DVR is coupled to an older STB, e.g., a legacy set top box, or is part of a DVR which does not support or have access to a high speed data connection, e.g., high speed Internet access.

In embodiments where the set top box or STB/DVR combination has a high speed data connection, as is common with many currently deployed cable set top boxes particularly those with integrated DVR functionality, a message may be sent to a server in the system or network to determine if content selected to be recorded is available via an on-demand service. In reply to such a message requesting on-demand content availability information, the STB receives content availability information in a response message. The response message can indicate that the content is not available for on-demand delivery or that it is available for on-demand delivery. The response message may include as part of the on-demand availability information the period for which the content will be available, e.g., the content availability start time (e.g., when it is not immediately available) and a content availability end time, e.g., when the selected content is available for a known limited duration.

In some cases the duration for which content will be available may be constrained by contractual obligations, e.g., to a period beginning with the initial broadcast of the content and ending within a pre-agreed time of the most recent broadcast, e.g., two weeks from the most recent broadcast time. The response to the on-demand availability inquiry may indicate the end time of the availability period without indicating the reason for the end time to the STB. The on-demand availability period may, and in some embodiments is, included in the VOD availability information communicated via a broadcast file in embodiments where on-demand availability information is provided via a broadcast file or list.

If a DVR determines that the user selected content is not available via on-demand content delivery, the selected content is recorded in the usual manner. However, in accordance with the invention, if it is determined that the selected content is available for on-demand delivery, e.g., via a VOD server, the user is presented with the option of having the content made available via VOD delivery rather than by recording.

If the user selects VOD delivery, and the content is already available, the content is added to the user's list of recordings. An indicator is included in the list of recordings making the user aware that while the content is in the user's list of recordings, it will actually be supplied via the on-demand server if the user selects the listed item for playback. The indication may be a text indication such as a subscript or superscript “OD” used to indicate the content is available via an on-demand server or by another visual indication such as highlighting of the entry with a particular color such as yellow or by using a particular font for the “on-demand” entries. If the user selected content which is to be provided via the on-demand service is not immediately available, e.g., because the content has not yet been broadcast and is not made available until broadcast, a time entry is entered in a list of user recording timers. The time entry for the content to be supplied via the “on-demand” service is set to the time the content will be made available via the “on-demand” service. In most embodiments this time will be equal to or earlier than the user selected content recording time. For example, if the user selects to record a television episode that has not yet aired, the time the episode first airs and/or becomes available via the on-demand service will control setting of the timer as opposed to the time of the broadcast initially selected by the user for recording. When an entry in the timer list corresponding to content to be provided via an on-demand service is reached, the timer causes the entry to be removed from the timer list and added to the list of recorded/on-demand content items, e.g., programs, available to the user of the DVR.

In various embodiments, for content with a limited on-demand availability period, information about the end time of the on-demand availability period is stored in association with information in the user's list of available content, e.g., recorded content or content which was selected to be available on-demand. Prior to the end of an on-demand availability period, on-demand content on the DVR available content list is downloaded and stored as recorded content so that it will remain available to the user beyond the period of on-demand availability. Such downloading is not performed for content which the user deletes from the content availability list prior to the on-demand availability time period was reached.

In some embodiments, a user can set desired retention times for content. The retention time for individual programs may be specified and/or a default setting set by the user of the DVR may be used. For example, the user may set a retention time associated with television programs or particular television programs to two weeks. If a television program which was selected for recording is not viewed within the retention time it is removed from the available content list.

The ability to set retention times for particular content allows a user to avoid filling the DVR with large numbers of programs the user is unlikely to watch while allowing the user to select a large number of programs to be made available via on-demand functionality. For example, if the user knows the television programs are normally available via VOD for a two week period from the time the programs are broadcast, the user may select a larger number of programs to be recorded, select the VOD option, and set the retention time to two weeks. Since the user set retention time does not exceed the VOD availability period, the user can have a vast number of television programs listed in their user controlled availability list without concern that they will be stored on the user's local hard disc which the user may reserve for movies or other content.

The methods and apparatus of the present invention provide benefits of both VOD functionality and DVR functionality in a manner that is relatively transparent to the user and which reduces the storage burden on the DVR as compared to embodiments where all content to be made available via the DVR is stored on storage space dedicated to the particular DVR user, e.g., local storage space or limited network storage space dedicated to the DVR user seeking to record content.

While the integration of user selected content titles and recorded titles on the same DVR list of available titles makes the VOD provided content and functionality similar to that which the user expects with regard to recorded content, some differences between the VOD supplied content and recorded content may exist depending on the particular embodiment.

In some embodiments, commercials provided with on-demand streamed content are different from the commercials which would have been recorded if the user selected broadcast content had been recorded. In addition commercials provided with on-demand streamed content may be provided at different times within or before a program and may be of different length than those which are included in a broadcast program. However the program content is the same. In the case of commercials provided with streamed, on-demand content, the commercials may be selected at the time of streaming, e.g., at playback time, as opposed to at the original broadcast or content recording time. In addition, in some embodiments, commercials provided with the on-demand streamed content are targeted to the individual user to whom the content is being streamed based on user information which has been pre-stored corresponding to the DVR/STB to which the content is streamed.

In the case of a recording of broadcast content, the commercials included with the program or other content selected for recording will be the commercials broadcast at the time the DVR recording was made. In cases where a user is interested in seeing the broadcast commercials, e.g., during the Superbowl or another major sporting event, a user may decline the on-demand option and have the content recorded in the usual manner.

The use of an on-demand server to provide content in response to a recording request may be referred to as “on-demand recording”. While the selection of “on-demand recording” may result in a title being listed in a list titled “my recordings” or some other list of available titles on a DVR where the list includes at least some user recorded content, the use of the “on-demand recording” option does not necessarily result in local storage space being used to record the actual content of the selected program. Thus, a user may select multiple programs to be “recorded” without using up the limited DVR storage space available to the user.

While described primarily in the context of a STB DVR embodiment, it should be appreciated that the methods and apparatus of the present invention can, and are in some embodiments, used with a network based DVR system where a user is provided a limited amount of storage space for storing user selected recordings of broadcast content or content which may be recorded from non-broadcast sources.

While in many of the described embodiments a user is given the choice of having content selected for recording to be supplied via an on-demand server or by recording the content and having the content locally supplied, in some embodiments the user is not presented the choice and content is supplied via the on-demand server as opposed to a local recording by default when the content to be recorded is available via the on-demand content server. In some particular embodiments, whether the DVR will default to the on-demand content option rather than the user being given the choice for each recording can be selected by the user. In such embodiments the user selected default option to be prompted or not with regard to possible on-demand recordings is stored in the DVR and used to control DVR operation. If the user selects for on-demand to be the automatic default, the user will not be prompted when content to be recorded can be supplied via the on-demand server and the content will default to the on-demand source rather than a local recording being made. However, if the user chooses to be prompted and provided the choice of whether the on-demand source or local recording is to be used, the user will be prompted when such a choice is available for a selected recording. As should be appreciated the user is also allowed to select the recording default to be local recording only in which case the on-demand recording option is disabled. The user selected default option is stored in the DVR in various embodiments which allow the user to set the default recording option.

Various additional features and advantages of the present invention are discussed in the detailed description which follows.

### BRIEF DESCRIPTION OF THE DRAWINGS

FIG. 1 illustrates an exemplary communications network implemented in accordance with the present invention.

FIG. 2 illustrates the signaling and steps associated with one exemplary method, in accordance with the present invention.

FIG. 3, which comprises the combination of FIGS. 3A, 3B, 3C and 3D, is a flowchart illustrating the steps of an exemplary method of handling a request for recording, in accordance with the present invention.

FIG. 4 illustrates an exemplary recording/VOD timer list in accordance with an exemplary embodiment.

FIG. 5 illustrates an exemplary table showing user scheduled recordings, e.g., programs and/or movies to be recorded, in accordance with one embodiment.

FIG. 6A illustrate an exemplary listing of user recordings, in accordance with an exemplary embodiment.

FIG. 6B illustrate an exemplary listing of user recordings which is a modified version of the listing of user recordings shown in FIG. 6A, in accordance with an exemplary embodiment.

FIG. 7 illustrates an exemplary set top box which may be used in the exemplary communications network of FIG. 1.

### DETAILED DESCRIPTION

Various embodiments relating to digital video recording and enhancing digital video recorder (DVR) functionally through the use of content delivery on-demand are described. Combining DVR functionality with a content on-demand service allows a user to receive the content, e.g. video and/or audio content, on-demand when desired instead of recording the content, e.g., on a Set Top Box (STB) which supports digital video recording functionality. Thus, in various embodiments, a user is provided access to a large amount of content as if it had been recorded by the user without having to locally record the content thereby saving disk space on the user's STB (Set Top Box) DVR (Digital Video Recorder) device. In some embodiments a user's list of recordings includes, in some embodiments, both locally recorded content and content the user selected to be recorded but which will be supplied via on-demand functionality. Thus, the combination of local recordings and on-demand functionality is relatively seamless from a user perspective.

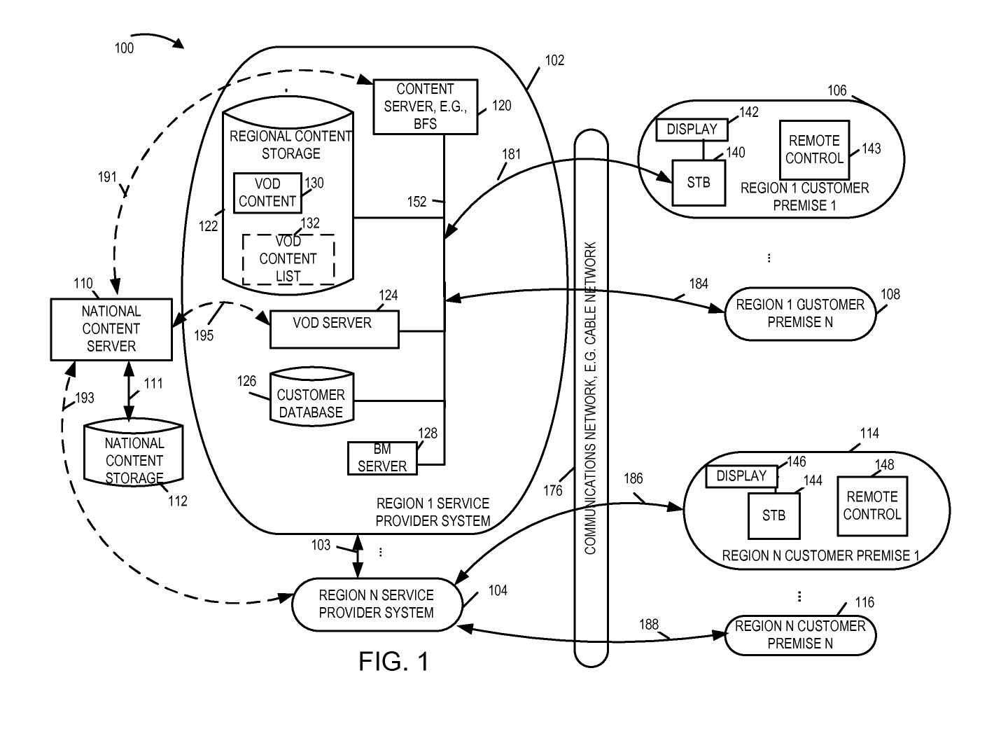

FIG. 1 illustrates an exemplary content delivery and distribution system 100 supporting various features of the present invention, implemented in accordance with one embodiment. The system 100 also supports the provisioning, selection, notification, and communication of content to customer premise equipment, e.g., STB devices, in accordance with various embodiments of the present invention. Exemplary system 100 includes a plurality of N regional service provider systems/Network head ends including a Region 1 network head end 102 and a Region N Network head end 104. Each regional service provider system, e.g., region 1 network headend 102, region N network headend 104, has a corresponding set of customer premises such as region 1 customer premise 1 106, . . . , region 1 customer premise n 108, and region N customer premise 1 114, . . . , region N customer premise n 116, each of which may include one or more STBs with content storage capability. System 100 also includes service provider national infrastructure including a national content server 110 with a corresponding national content storage 112.

Region 1 customer premise 1 106 is coupled to region 1 network headend 102 via the communications network 176, e.g. a cable network. Communications link 181 traversing the service provider's cable network 176 couples set top box 140 to the region 1 network headend's local network 152. Similarly, region 1 customer premise N 108 is coupled to the local network 152 via link 184 which traverses service provider cable network 176. Region N customer premise 1 114 is coupled to region N network head end 104 via a communications link 186. Similarly, region N customer premise N 116 is coupled to region N network head end 104 via a communications link 188.

The network headends such as region 1 network headend 102 and region N network headend 104 may be implemented at a cable network office or site including multiple servers and databases which are coupled together. The network headends 102, 104 of the different regions are coupled together, e.g., via link 103. Each of the network head ends (102, 104) is also coupled to the national content server 110 thereby allowing content to be passed between the network headends and the national content server 110. Link 193 indicates that region N headend 104 is coupled to national content server 110. The National content server 110 is coupled to National Content Storage 112, which stores content which can be delivered nationally, via link 111.

Region 1 network head end 102 includes a content server 120, a Regional content storage 122, a video on-demand (VOD) server 124, a customer database 126, and a business management (BM) server 128. In some embodiments the content server 120 is e.g., a broadcast file server (BFS), e.g., a server used to broadcast television programs, other content and broadcast guide information. VOD content on demand information may also be broadcast by the BFS. The various elements in the network headend 102 including the servers and the customer database are coupled together via a local network 152 over which data and information may be interchanged. The local network 152 is coupled, e.g., via one or more network interfaces, to other networks and/or devices. In some embodiments the region 1 headend 102 is coupled via a network interface to the communications network 176, e.g., a cable network, and may also be coupled to the Internet. The customer database 126 is used to store customer account information, e.g., customer account/user name, address, STB identification information, STB capability information, and information about which services the customer subscribes to.

The BFS 120 is responsible for broadcasting programming content and/or other information to one or more customer STB devices including the STB 140. In some embodiments the available VOD content list 132 is broadcast by the server 120 to various STB devices being served by the headend 102, including STB 140 located at customer premise 106. The VOD content list 132 is a list of items, i.e., content, available for on-demand delivery to the customers. The list may include information such as content identification information such as program titles and episode numbers, information on the time the content will be available for delivery and/or other information such as the resolution of the program content. Some programs may be available in a different resolution via the VOD service than they are available from broadcasts. When being prompted regarding a VOD alternative to an actual recording, the user is made aware, in some embodiments, if there is a difference in the resolution of the VOD and broadcast versions. A user may find the VOD option particularly desirable rather than an actual recording for content which is available on demand in HD which can take a significant amount of storage space to record or because the HD version is not being broadcast.

In various embodiments, the STB devices store the received available VOD content list 132. In other embodiments, the set top boxes may dynamically access a network based VOD content list when needed, e.g., in response to a recording request. When the available VOD content list is updated, e.g., due to addition or removal of on-demand content, either the updated VOD content list is broadcast to the STB devices or update information is broadcast to the STB devices so that the STB devices can update the old available VOD content list.

The VOD server 124 can communicate with the network regional content storage 122, to access available on-demand content, e.g., VOD content 130, and download the content to a customer STB/DVR which requested on-demand content, in accordance with the invention. The VOD server 124 controls access VOD content and may limited access to stored programs based on contractual obligations. For example, the VOD server may limit access to content so that content becomes available upon broadcast or following its initial broadcast on a program channel. In addition, some content may have a limited availability period corresponding to its initial or last broadcast over a network program channel. For example content may be available via the VOD sever from the time of its initial content and for a two week period following its most recent network broadcast. After expiration of the on-demand availability time period the VOD server may delete the content or prohibit the content being supplied in response to requests for the content.

In some embodiments, in addition to supplying actual content, the VOD server also response to requests for content availability information. In some embodiments set top boxes may request such information as it is needed rather than rely on the information transmitted via the BFS server. Thus, at least in some embodiments the VOD server 124 is responsive to a content availability information request from the customer STB devices. The VOD server 124 is capable of accessing the on-demand content 130 stored in the regional content storage 122 and delivering, e.g., streaming it, to the customer premise equipments, e.g., Set Top Box (STB) 140, in accordance with the invention.

The regional content storage 122 includes content, e.g., programs such as movies for which there is a high degree of anticipated demand such as content of recent releases, content of regional favorites, content of seasonal favorites, etc. The regional content storage 122 further includes video on-demand (VOD) content 130 and available VOD content list 132. In some embodiments the VOD content 130 includes on-demand programs/movies which are high in demand, customer ordered video on-demand movie/programs that have been recently downloaded from national content storage 112, etc. Some of the on-demand content included in VOD content 130 is time sensitive and may be deleted after a short period of time from the storage 122.

The BFS 120 and VOD server 124 communicate information, e.g., content and information on available content to the STB 140, as shown by link 181. Link 181 can also be used to send signals to the service provider system 102 and elements included therein. Link 181 traverse at least a portion of a cable network in some embodiments. Business management server 128 processes billing information corresponding to region 1 customers, e.g., updating billing charge information in response to premium content purchases, and/or other activity, processes bill payment information, e.g., credit card transactions, deductions from debit accounts, mail bills, and/or processes discount and/or coupon information.

Via cable network 176, the devices in the network headend 102 can communicate video, audio and/or other content, programming related information and/or other information to set top boxes and/or computers located at the customer premises 106, 108 coupled to the cable network 176.

Each customer premise 104, 106 includes a set top box and a display device. Region 1 customer premise 1 106 includes a first set of equipment, e.g., set top box (STB) 140, a display device 142 and a remote control device 143. It should be appreciated that a STB device such as STB 140 can be integrated in a device which also includes a display. In some embodiments, the display 142 could be an external television as is commonly the case. However, it should be appreciated that the STB 140 can be integrated in a device which also includes the display 142. The STB 140 includes DVR functionality and stores recorded content, e.g., content selected by the user for recording. One or more customer premises may also include computers capable of receiving and displaying video. Although not shown, customer premise 106, 108 may also include additional STBs and display devices. The user can make program selections and/or can control the STB 140 to perform various functions via the remote control 143. The STBs support video and, optionally, E-mail functionality. The STB 140 can be used to send information to the network headend 102 in addition to receiving content, and other programming content and/or information from the headend 102. The STB devices in the system 100 may, and often do, include DVR functionality and the storage of user selected content.

The STB 140 in Region 1 customer premise 1 106 can interact and communicate with the servers in the region 1 network headend 102 through the communications network 176. In some but not necessarily all embodiments, the STB 140 in region 1 customer premise 106 interacts with the VOD server 124 to determine if one or more programs/movies which the customers wishes to record are available for on-demand delivery. In other embodiments the STB makes this determination based on on-demand content availability information it receives and stores. It should be appreciated that various other interactions between the STB and the elements in the headend 102 are possible, e.g., for supporting customer ordering of services and/or content, reporting of status of ordered services, and customer account management functions etc.

National content server 110 is coupled to content server 120 via link 191. Similarly national content server 110 is coupled to a content server (not shown) of region N network headend 104 via link 193. Various alternative interconnection topologies between the regional network head end and a national service provider system infrastructure are possible. National content server 110 processes requests for content and accesses content from national content storage 112, e.g., forwarding requested content via link 191, 195 to the server 120 and the VOD server 124 respectively, in the event when a user requests a content which is not available locally to the servers 120, 124. National content storage 112, typically has a greater storage capacity than the storage capacity of an individual regional content storage, e.g., regional storage 122.

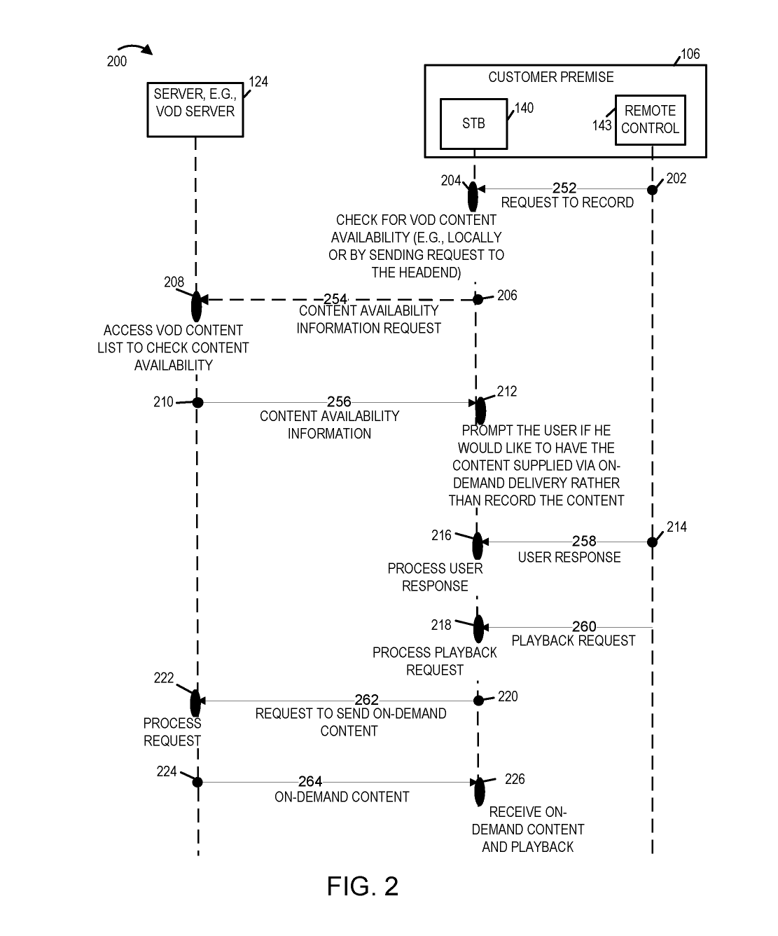

Having generally discussed the exemplary system shown in FIG. 1, an exemplary method will now be discussed in detail with regard to the example shown in FIG. 2. Elements of the system 100 shown in FIG. 1 which participate in the exemplary method being discussed in the FIG. 2 example are shown at the top of FIG. 2 and bear the same reference numbers as used in FIG. 1. Messages, information, content and/or signals communicated between devices are represented in FIG. 2 using arrows.

At the top of FIG. 2, various elements 200 of the system 100 are shown which may participate in the exemplary method of handling a recording request from a user located at the customer premise 106, e.g., customer home, in accordance with one embodiment of the invention. The illustrated components 200 include, user STB 140 including DVR, user remote control 143, a server, e.g., Video on-demand (VOD) server 124, located outside the customer premise 106.

FIG. 2 illustrates the steps and associated signaling used in an exemplary method of the present invention. In the illustrated embodiment, when a user requests recording of some content, the STB device makes a determination to check if the content selected for recording is available for on-demand delivery, i.e., for viewing on-demand. If so, the user is provided an opportunity to access the same content on-demand when desired, e.g., in some embodiments without any extra charge, instead of recording it on his STB/DVR device. Both the service provider and the user are benefited by this feature as the user will save disk space on his STB device and can use for other recordings, and the service provider will not have to frequently upgrade the user STB devices to include greater memory for storage. In addition, in some embodiments, when the content is provided via the VOD server, the content is supplied with targeted advertisements which have been selected based on known information corresponding to the set top box, e.g., set top box user demographic information, being supplied with the on-demand content. The service provider can charge a premium for such targeted advertisements over the revenue obtained from advertisements included in broadcast content which the user might have alternatively recorded.

As is discussed below, in the exemplary embodiment the process is initiated by a request from the user at customer premise 106 to record some content. For example, the user may schedule a recording for some movie/show which is currently being viewed, and/or is scheduled to be broadcast at a given time. The user may, and normally does use the remote control 143 to send user commands to the recording device, which in this example is the STB 140 including DVR capability.

To facilitate better understanding of the exemplary method of the present invention, consider one example. Consider that the user at customer premise 106 is viewing the program guide which shows the presentation schedule for various programs/movies, e.g., a grid guide showing the date and time of the scheduled broadcast of various content, e.g., programs. The user may find something of interest, e.g., a movie and/or other program content such as a program episode, which is scheduled to be broadcast on a certain date, time and program channel. The user may indicate an intent to record the item of interest, e.g., by pressing a record button on the remote while the content of interest is highlighted on the display. It should be appreciated that the above example of a user selecting content for recording is provided for discussion purposes and that other scenarios are possible with regard to selecting content to be recorded. Selection of content to be recorded results a record request 252 being sent from the remote control to the STB 140 signaling a user desire to record the user selected content, e.g., program, movie or some other content. The STB 140 receives and processes the request 252 in step 204.

In accordance with the exemplary method of the invention, the STB 140 is configured to determine, upon receiving a recording request from the user, whether or not the requested content is available for on-demand delivery.

In some embodiments, the STB determines on-demand content availability based on a stored list of available content, e.g., a list received from the broadcast file server 120. The VOD content list 132 is a list broadcast by a server, e.g., the BFS 120 at headend 102, and received by the STB 140. In some such embodiments the STB 140 stores the received VOD content list 132. The VOD content list 132 includes information regarding content which is available to one or more STBs for on-demand delivery. Thus in some embodiments when determining whether the requested content to be recorded is available, the STB accesses the list to check if the requested content is available.

However in some other embodiments, such as the one illustrated in FIG. 2, determining if the content selected to be recorded is available for on-demand delivery involves communicating with an external information source such as VOD server 124 to determine on-demand content availability. In the FIG. 2 embodiment, in order to determine whether the requested content to be recorded is available for on-demand delivery, the STB 140 sends, in step 206, a request message 254 to the VOD server 124 to get information as to whether the requested content is available for on-demand delivery. In some embodiments, message 254 requesting content availability information includes information identifying the requested content, e.g., movie title, program title and episode number, and/or scheduled presentation time and channel number.

In step 208, the VOD server 124 receives the request message 254 indicating a request for content availability information. Further in step 208 the content server 120 processes the request message determines whether the content indicated in the request message 254 is available for on-demand delivery. The content may be available either locally or from a remote server such as the national content server. The determination may be made based on stored content availability information known or accessible to the VOD server 124. The availability information may include information on the time period for which content will be available, e.g., the start time of content availability if it is not currently available and the end time if the content is available for a limited time periods.

The content may be deemed to be available for on-demand recording in response to a signal indicating a desire to record the content if the content is currently available or will be available at or prior to the user selected recording time. For example, a program which air initially at the user selected recording time may become available on-demand delivery at the time of the user selected recording time or prior to the user selected recording time due to an earlier broadcast than the one the user selected to be recorded. In such cases, the content would be indicated as being available on-demand for purposes of responding to the user's recording request. If the content will not be available at or within a few minutes of the user selected recording time, the content is deemed not to be available for purposes of responding of responding to the user's recording request. The response to the content availability information request may include availability information from which the STB 140 makes the final determination as to whether the content should be considered available or not for purposes of responding to the recording request or the server may indicate whether it is available or not for purposes of responding to the content recording request.

In step 210 the VOD server 124 sends content availability information in a response message 256 to the STB 140. In various embodiments the content availability information includes information whether or not the content is available for on-demand delivery and for how long, e.g., a content availability time period, for the requested content. In some embodiments the availability time period is a function of one or more contractual obligations/regulations that the service provider system is supposed to obey, and thus such obligations may, and sometimes do, limit when a given item, e.g., a movie, show etc., becomes available for on-demand delivery, and for how long it remains available for on-demand delivery.

The STB 140 receives the content availability information in step 212 and performs processing. Assuming that the STB 140 determines that the content will be available for on-demand delivery at (e.g., within a few minutes) or prior to the user selected recording time, the STB 140 determines if it should prompt the user with on-demand recording option information. If however, the user has already specified a default preference with regard to recording options, e.g., in response to a previous prompt, the user need not be prompted again and the users previously supplied default selection is used in determining if the on-demand content should be used instead of proceeding with recording.

Assuming the content was determined not to be available on-demand, the content would be recorded in accordance with the user's record request since on-demand content supply is not possible.

In FIG. 2, the text under step 212 shows that in the particular FIG. 2 example, the STB 140 prompts the user if the user would like to have the requested content supplied via on-demand delivery rather than record the content. The STB 140 controls the display device 142 to display the interactive prompt so that the user is presented with an opportunity to take desired action. For example in one embodiment the following interactive message is displayed to the user “Would you like to have the MOVIE ABC available as an on-demand recording instead of locally recording the Movie? SELECT YES or NO”. After displaying the message the STB 140 monitors for a control signal indicating a response from the user.

In step 214 the user sends user response 258 indicating how the user would like to proceed. Depending on the user's desire, the user may either select one of the options. For the purpose of this example we assume that the user wishes to have the content supplied via on-demand delivery rather than recording. Thus user response 258 in this example indicates that the user would like to have the requested content supplied via on-demand delivery.

The STB 140 receives the user response 258 in step 216 and performs processing to recover the user instructions. In accordance with the invention, the STB 140 then determines if the requested content is currently available for on-demand delivery, and if so the STB 140 updates the user list of recordings, e.g., the list of recorded items, to indicate that the requested content is available for on-demand delivery and the user can playback when desired. Thus, from the users perspective the content appears as if it has been immediately recorded even though the user selected recording may have related to a future time slot.

In some embodiments in the event when the requested content is not immediately or currently available for on-demand delivery but the content will become available at a future time, e.g., at or prior to the user selected time at which the user wanted to record the content, the STB 140 keeps track of the time and updates the user list of recordings when the content becomes available for on-demand delivery. For example if the user is scheduling a recording for a movie which is to be initially broadcast a day later, it is possible that the movie is not immediately available for on-demand delivery but will become available for on-demand delivery a day later at the time of its scheduled broadcast. User recordings which do not immediately take place, whether they are to be implemented as on-demand recordings or actual recordings on the local storage space result in corresponding recording timers being set. The recording timers control when the actual recording takes place and/or when the user's recording list is updated to reflect the on-demand availability of content selected by the user for recording.

It should be appreciated that since on-demand recordings do not involve locally recording content, the user is not constrained by the number of STB tuners with regard to how many programs the user can select for recording when the “on-demand” feature is used and the selected programs can be supplied on-demand. Accordingly, in some embodiments a user may, and sometimes does, select more programs to be recorded simultaneously than the STB is capable of physically recording simultaneously with some of the recording requests being satisfied via on-demand content supply rather than locally recording all the programs selected for recording simultaneously.

The STB 140 monitoring for user commands, e.g., recording and playback commands on an ongoing basis and responds to commands which are received.

In the FIG. 2 example, in step 218 the STB 140 receives a user playback request, i.e., a request to playback content. The STB 140 processes the request to check if the playback request is for the content which the user agreed to have supplied via on-demand delivery. In this example we consider that the playback request is for the content which the user agreed to have via on-demand delivery. Thus in step 220, the STB 140 sends a request 262 to the VOD server 124 to send the requested content. In step 222 the VOD server receives the request 262 from STB 140 for the on-demand delivery of the requested content. The VOD server 124 processes the request and an on-demand session is established between the end devices, i.e., the VOD server 124 and the STB 140. In step 224, the VOD server sends the requested content to the STB 140 as shown using arrow 264. The STB 140 receives the content in step 226 and the user is able to watch the requested content. Thus it should be appreciated from the above discussion that the user is able to view the content at the desired time without having to record the content on the STB 140 and waste the disk space. Furthermore, the user's interaction with the VOD system is transparent to the user with the playback operation/request being the same, in some embodiments, for locally stored content as it is for content which has been added to the user's list of recordings in accordance with the on-demand recording feature of the present invention.

If content on the user's list of recordings is locally recorded, it is retrieved from the local storage as opposed to via the VOD server.

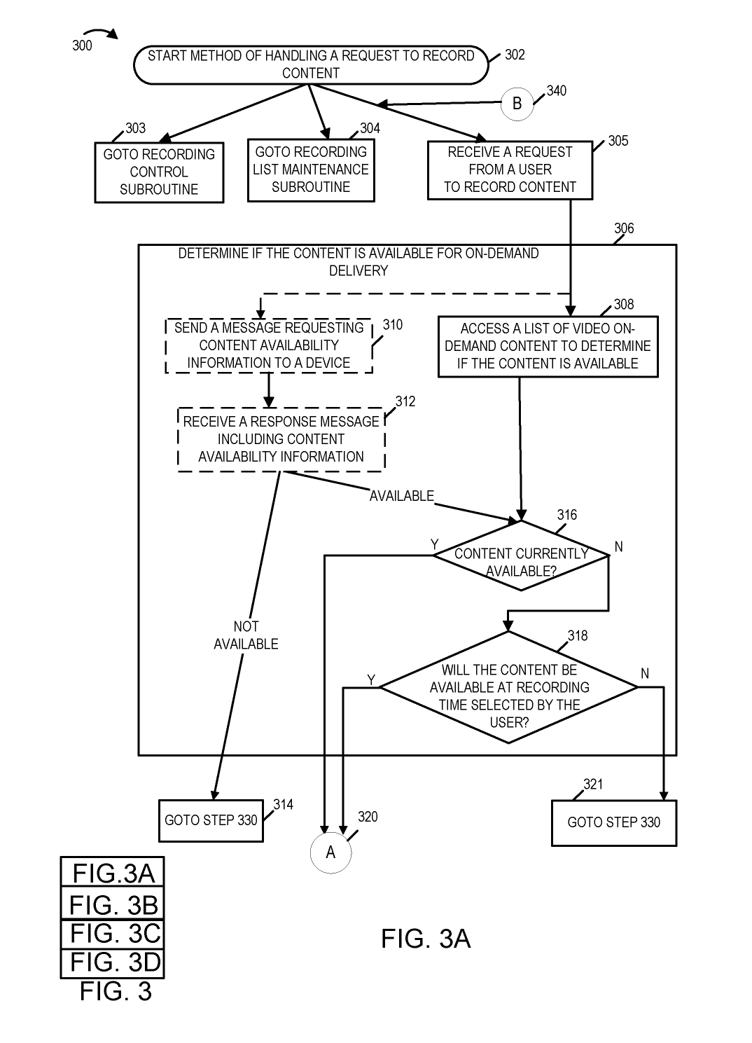

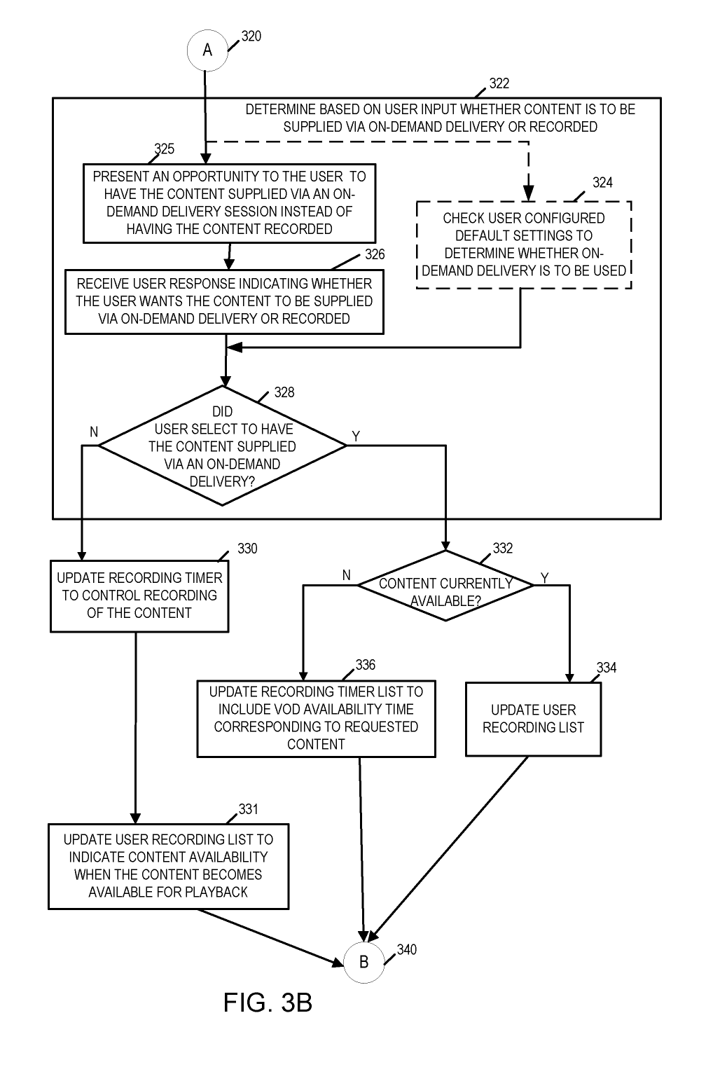

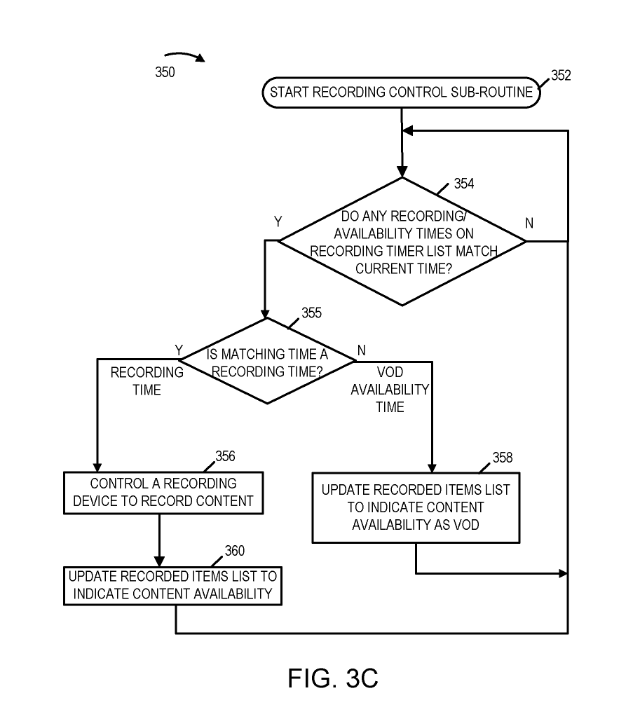

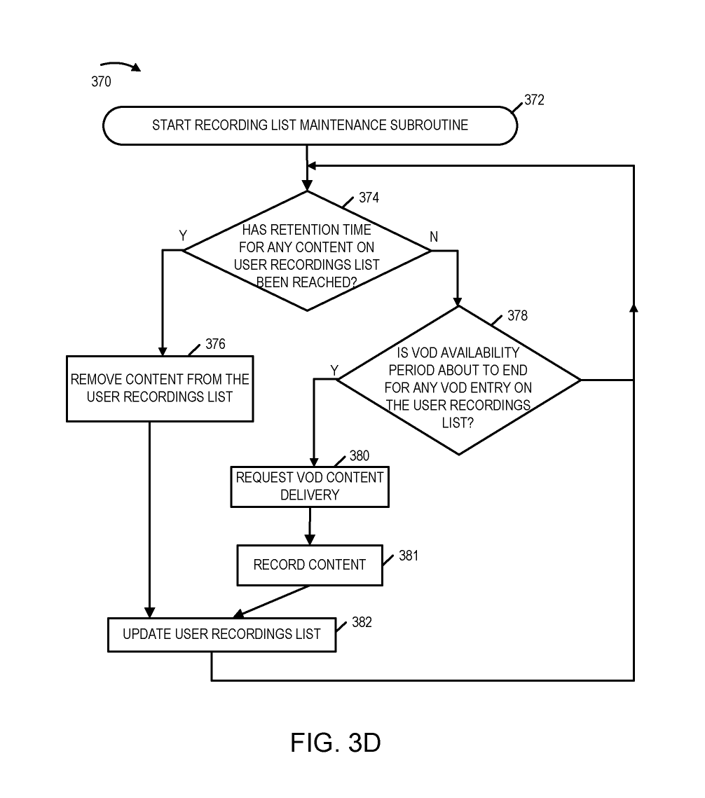

FIG. 3, which comprises the combination of FIGS. 3A, 3B, 3C and 3D, illustrates a flowchart 300 showing the steps of an exemplary method in accordance with an exemplary embodiment of the invention. The method of flowchart 300 can be implemented by a set top box devices such as STB 140, 144 shown in FIG. 1. For the purpose of discussion, consider that the steps are performed by STB 140. The exemplary method starts in step 302 where the STB 140 is powered on and initialized. The STB 140 performs various different functions at different times in accordance with the invention, and the operation proceeds from step 302 to steps 303, 304 and 305 along three parallel processing paths as shown.

Along the first processing path, the operation proceeds from step 302 to step 303 to the recording control subroutine which is discussed in detail in FIG. 3C. Along the second processing path, the operation proceeds from step 302 to step 304 to the recording list maintenance subroutine which is discussed in detail in FIG. 3D.

Along the third processing path, the operation proceeds from step 302 to step 305 wherein the STB 140 receives a signal from a user remote control indicating a request by the user to record content. The request to record may be a request to record some content being currently broadcast, or some content which is scheduled to be broadcast in the future. The request to record content may, and in some embodiments is, a request to linear broadcast content, e.g., a program or sporting event scheduled to be broadcast during a contiguous time interval or program slot. For the purpose of discussion, consider an example where the user views the program guide and selects some content for recording, e.g., a movie, which is scheduled to be broadcast at a future time. The user selection of the content for recording from the program guide is represented as a request to the STB 140 to record user selected content.

Operation proceeds from step 305 to step 306. In step 306 in accordance with the invention upon receiving the request to record, the STB 140 determines whether or not the requested content is available for on-demand delivery. In various embodiments in order to determine whether or not the content to be recorded is available for on-demand delivery, the STB 140 performs one or more of the steps 308, 316, 318, 310, and 312. In the FIG. 3 embodiment, the step of determining the availability of content for on-demand delivery includes performing steps 308, 316 and 318. Alternatively in some embodiments the determining step 306 includes performing steps 310 and 312 which are shown using dashed boxes to indicate that they are optional.

In step 308 the STB 140 accesses a list of available VOD content, e.g., VOD content list 132, to make the determination of availability. In some embodiments the VOD content list 132 is broadcast by the BFS 120 so that various STB devices served by the headend 102 get information regarding the VOD content available at the headend for on-demand delivery. The STB 140 receives and stores the available VOD content list 132. The STB 140 checks the entries listed in the VOD content list 132 to determine if there is an entry corresponding to the user requested content. In some embodiments in addition to the information regarding what content is available for on-demand delivery, the VOD content list 132 also includes information regarding, e.g., when the content becomes available for on-demand delivery and the availability duration or the time period for which content remains available for on-demand delivery. Operation proceeds from step 308 to step 316.

An alternative path is shown using steps 310 and 312 which are performed in some embodiments as an alternative to step 308. In such embodiments, to determine whether or not the content is available for on-demand delivery, in step 310 the STB 140 sends a message (e.g., message 254) to a server, e.g., the VOD server 124, requesting content availability information, i.e., whether or not the requested content is available for on-demand delivery. The operation proceeds from step 310 to step 312. In step 312 the STB 140 receives a response message including the content availability information. In various embodiments the received content availability information includes information indicating whether or not the content is available for on-demand delivery and for how long, e.g., a content availability time period, for the requested content. In some embodiments the availability time period is a function of one or more contractual obligations/regulations that the service provider system is supposed to obey, and thus such obligations may, and sometimes does, limit when a given content item, e.g., a movie, show etc., becomes available for on-demand delivery, and for how long it remains available for on-demand delivery. Thus based on the received content availability information in step 312 the STB 140 determines if the requested content is available for on-demand delivery. If the content is not available for on-demand delivery the operation proceeds from step 312 to step 314 wherein the operation is controlled to proceed to step 330. If the content is available for on-demand delivery the operation proceeds from step 312 to step 316.

Returning to step 316. In step 316 the STB 140 determines whether the content is currently available. Step 316 is a determination and decision step and thus in this step, based on the determination whether or not the content is currently available, a decision is made how the operation will proceed to the next step. In step 316 a check is performed using the information indicated in the VOD content list 132 to determine if the requested content is currently or immediately available for on-demand delivery. If it is determined that the content is not currently available the operation proceeds from step 316 to step 318. If the content is currently available for on-demand delivery, the operation proceeds from step 316 to step 322 via connecting node A 320.

In step 318, it is determined whether the content will be available for on-demand delivery at or prior to the recording time selected by the user. If it is determined that the content will not be available at or prior to the selected recording time of the content, the operation proceeds from step 318 to step 321 wherein the operation is controlled to proceed to step 330. If it is determined that the content will become available at or prior to the selected recording time of the content, the operation proceeds from step 318 to step 322 via connecting node A 320.

In step 322 it is determined based on a user input whether content is to be supplied on-demand delivery or recorded. Determining step 322 may be performed in different ways in different embodiments. In some embodiments steps 325 and 326 are performed as part of the determining step 322, while in some other embodiments step 324 is optionally performed as an alternative to steps 325 and 326.

In the optional step 324, the user configured default settings for the STB 140 are checked to determine whether on-demand delivery is to be used when a content item is selected for recording. As discussed earlier, in accordance with one aspect of some embodiments of the invention the user is allowed to configure the STB 140 settings in such a manner so that whenever the user selects some content to be recorded, by default on-demand delivery option will be selected if the selected content is available for on-demand delivery, rather than real recording on the STB DVR. In contrast to the above scenario, in some embodiments the user may configure the STB settings such that by default the STB 140 is controlled to record the content locally rather than having the content delivered via on-demand delivery. In some embodiments the user can configure the default settings to control the STB 140 to locally record one specific type of content while having some other specific type of content delivered via on-demand delivery if available. For example, the user may configure the settings so as to have specific sports programs recorded locally while having movies available via on-demand delivery. Thus in step 324, determination is made to check the default settings and control the recording operation according to the user default settings. Operation proceeds from step 324 to step 328.

Returning to step 325. In step 325 the user is presented with an opportunity, e.g., by a prompt displayed on the display 142, to have the content supplied via on-demand delivery instead of having the content recorded. For example a message may be displayed on the screen prompting the user to select one of the available options. An exemplary message may display “Would you like to have MOVIE 123 delivered on-demand instead of recording? SELECT YES or NO”. Operation proceeds from step 325 to step 326. In step 326 a user response is received indicating the user's preference for the selected content, i.e., whether the user wants content to be supplied via on-demand delivery or recorded on the recording device.

Operation proceeds from step 326 to step 328. In step 328 the STB 140 determines, based on the user's response, whether or not the user selected to have the content supplied via on-demand delivery. Based on the determination, the operation accordingly proceeds to the next step. If it is determined that the user has chosen to have the content supplied via on-demand delivery, the operation proceeds to step 332. However if it is determined that the user has chosen to have the content recorded instead, the operation proceeds to step 330. In step 330 a recording timer, which is used to control content recording at the scheduled time, is updated to control the recording of the selected content at the recording time. Operation proceeds from step 330 to step 331. In step 331 the STB 140 updates user list of recording to indicate availability of the recorded content when the content becomes available for playback, for example, after the completion or partial recording of the selected content. The operation proceeds from step 331 back to step 305 via connecting node B 340. The user list of recordings is a list of the items that the user has recorded and/or which are available for on-demand delivery.

Returning to step 332. Following the determination that the user has chosen to have the content supplied via on-demand delivery, in step 332 a check is performed to determine whether or not the content is currently available for on-demand delivery. This check is similar to the determination made in step 316. If it is determined that the content is instantly available for on-demand delivery, the operation proceeds from step 332 to step 334 otherwise the operation proceeds to step 336.

In step 334 the STB 140 updates the user list of recordings to reflect that the content is available for playback. In various embodiments an indicator is included in the user list of recordings, making the user aware that while the content is in the user's list of recordings, it will actually be supplied via the on-demand delivery if the user selects the listed item for playback. In one embodiment the indication is a text indication such as a subscript or superscript “OD” indicating that the content is available via an on-demand server. The operation proceeds from step 334 back to step 305 via connecting node B 340.

When it is determined that the content is not currently available for on-demand delivery, the operation proceeds from step 332 to step 336. In step 336 the recording/VOD timer list is updated to include VOD content availability time corresponding to the user requested content. The recording timer list includes the time entries corresponding to various user requested contents which are either to be recorded or have to be supplied via on-demand delivery. A timing entry corresponding to an item to be recorded indicates the time of scheduled recording. Similarly a timing entry corresponding to some content selected to be supplied via on-demand delivery indicates the time the VOD content becomes available for on-demand delivery. In some embodiments the user is provided the opportunity to choose VOD delivery of selected content rather than recording the content on the STB DVR, only when the time at which VOD content becomes available is the same as or prior to the time that the user wanted to record the content. The operation proceeds from step 336 back to step 305 via connecting node B 340.

Now referring to step 303 of FIG. 3A. Operation proceeds from step 303 to step 352 wherein the STB 140 starts executing the recording control subroutine 350 shown in FIG. 3C. Recording control subroutine 350 starts in step 352 and the operation proceeds to step 354. In step 354 the STB 140 determines if any recording/content availability times on the recording/VOD timer list matches current time, e.g., current time on the system time clock maintained by the STB 140. The STB 140 matches the current time on the system clock to the recording/availability times on the recording timer list to determine if an action is to be taken, for example if recording has to be performed for some content and/or user's list of recordings has to be updated to indicate VOD content availability. If none of the recording/availability times on the recording timer list matches current time, no action is taken until the next possible matching time is detected as indicated by the arrow returning from the “N” output of step 354 back to the input of step 354. However if it is determined that any recording/availability time on the recording timer list matches current time, the operation proceeds to step 355.

In step 355 a check is performed to determine if the matching time entry on the recording/VOD timer list corresponds to a content recording time or to a VOD availability time. If it is determined that the matching time entry corresponds to a content recording time, the operation proceeds from step 355 to step 356. In step 356 the STB 140 controls a recording device, e.g., a digital video recorder, to record the content corresponding to the matching time entry on the recording timer list. The operation proceeds from step 356 to step 360 wherein the STB updates user's list of recordings, i.e., list of recorded items to indicate the availability of the recorded content for playback. The operation proceeds from step 360 back to step 354.

If in step 355 it is determined that the matching timing entry on the recording timer list corresponds to a VOD availability time then the operation proceeds from step 355 to step 358. The VOD availability time indicates the time, a particular content corresponding to the time entry, becomes available for on-demand delivery. The recording timer list includes entries corresponding to one or more “on-demand recordings”, e.g., movies, shows etc., that the user has selected for on-demand delivery rather than having them recorded on the STB DVR. In step 358 the STB 140 updates the user's list of recordings to indicate that the availability of content as VOD content. The user may select any available item from the user's list of recordings for playback.

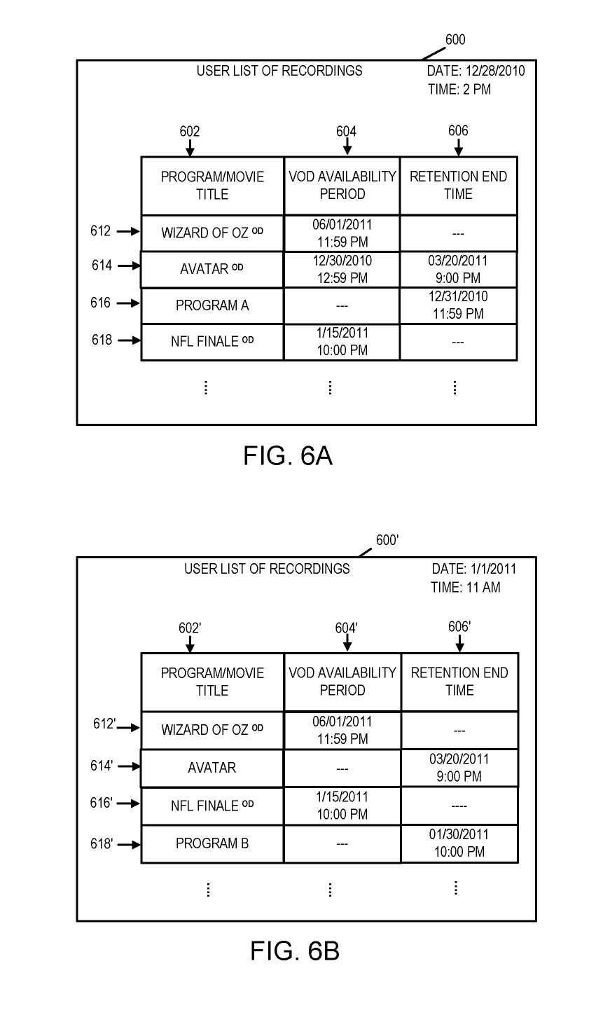

Now referring to step 304 of FIG. 3A. Operation proceeds from step 304 to step 372 wherein the STB 140 starts executing the recording list (user list of recordings) maintenance subroutine 370 shown in FIG. 3D. As the name suggests, the recording list maintenance subroutine is executed to maintain the user's list of recordings and to keep it updated, e.g., to reflect addition and deletion of content from the list. In various embodiments the recording list maintenance subroutine is executed on a periodic basis, for example, every 1 minute, or some other time interval. An exemplary user's list of recordings is discussed later with regard to FIGS. 6A and 6B. Recording list maintenance subroutine 370 starts in step 372 and the operation proceeds to step 374. In step 374 the STB 140 determines if retention time for any content on the user's list of recordings has been reached. The retention times for various items listed on the user's list of recordings can be user defined retention periods. However the retention/availability time corresponding to a VOD entry on the list, e.g., content which is available via on-demand delivery could be, and in some embodiments is, defined by the service provider due to contractual obligations and/or other obligations. As will be discussed now, in accordance with one feature of some embodiments the STB 140 is configured to remove one or more items from the user's list of recordings when the retention time corresponding to such one or more items expires.

If it is determined that the retention time for any content on the user's list of recordings has been reached, the operation proceeds from step 374 to step 376. In step 376 the content corresponding to which the retention time has expired, is removed from the user list of recordings. The operation proceeds from step 376 to step 382.

If in step 374 it is determined that the retention time for any content on the user's list of recordings has not been reached, the operation proceeds from step 374 to step 378. In step 378 a determination is made to check if VOD availability time period for a VOD entry included in the user's list of recordings is about to end, e.g., if it is within a predetermined amount of time relative to the end of the VOD availability period, e.g., within 48 hours, 24 hours, 8 hours, or less than an hour depending on the particular embodiment of the end of the VOD availability period. If the availability time for a VOD entry is within a predetermined amount of time window, e.g., 60 minutes, of the end of the VOD availability period, it is considered that the availability time for that particular VOD entry is about to expire. In some embodiments the user configures the STB 140 settings such that a particular time interval prior to the end of the availability time of a VOD entry (on-demand content), the STB 140 download and records the on-demand content on the DVR before it becomes unavailable.

If in step 378 it is determined that the VOD availability time period for a VOD entry included in the user's list of recordings is not within the predetermined time range, i.e., not about to expire, no action is taken until the next determination is made as indicated by the arrow returning from the “N” output of step 378 back to the input of step 374. However if it is determined that the VOD availability time period for a VOD entry is about to end, the operation proceeds from step 378 to step 380. In step 380 the STB 140 requests on-demand delivery for the VOD content entry for which the availability time is about to end. In various embodiments the request is sent to the VOD server 124 to deliver the content. In some embodiments, the device sending the request, e.g., STB, includes a network interface configured to signal a remote storage device to provide said requested content when the availability of said requested content via on-demand delivery is about to expire. The remote storage device maybe, and in some embodiments is, a HTTP sever with access to said requested content.

a network interface configured to signal a remote storage device to provide said requested content when the availability of said requested content via on-demand delivery is about to expire

Operation proceeds from step 380 to step 381. In step 381 the STB 140 receives the VOD content and controls the recording device to record the content. The operation proceeds from step 381 to step 382. In step 382, user list of recordings is updated to reflect the changes to the list, i.e., addition and/or removal of content from the list. Operation proceeds from step 382 back to step 374.

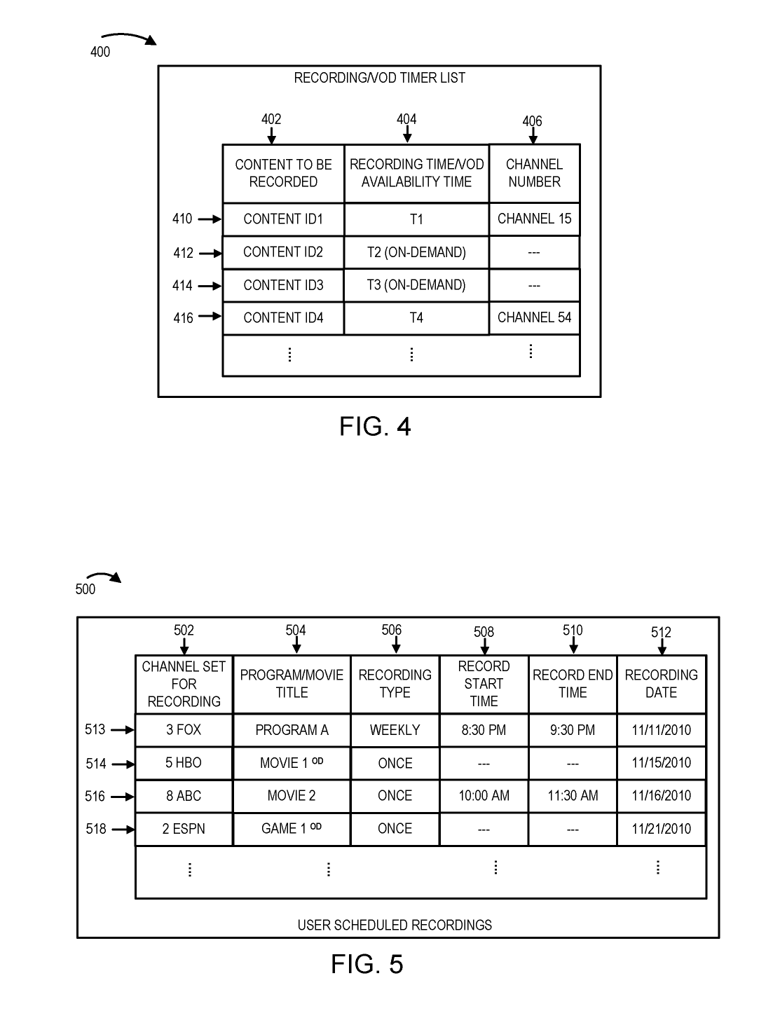

FIG. 4 illustrates an exemplary recording/VOD timer list 400, in accordance with one exemplary embodiment of the invention. The recording timer list 400 includes recording and/or availability time information corresponding to various user requested contents which are either to be recorded or have been selected for supply via on-demand delivery, e.g., upon playback. A timing entry corresponding to an item, e.g., content such as a movie, to be recorded indicates the time of its scheduled recording. The time of recording may also be the time the item becomes available for playback, however it should be appreciated that the full content may not be necessarily available for playback at that time. A timing entry corresponding to an item, i.e., content, selected to be supplied via on-demand delivery indicates the time that content becomes available for on-demand delivery.

As shown, the recording/VOD timer list 400 is presented in the form of a table. The recording timer list 400 is maintained by the set top box devices such as STB 140, and is used in some embodiments to control recording of content and/or for updating the user's list of recorded items. In the recording/VOD timer list 400, each row corresponds to a different content identifier. A content identifier is a program name, program identifier number and/or another identifier used to identify the content to be recorded or made available via on-demand delivery. Row 410 corresponds to content ID 1, Row 412 corresponds to content ID 2, row 414 corresponds to content ID 3, while row 416 corresponds to content ID 4 and so on.

Columns 402 include the content identifiers, each entry in column 402 corresponding to a different content identifier. Column 404 includes time entries, each entry in column 404 represents a time at which the corresponding content identified in the corresponding row is to be recorded or becomes available for on-demand delivery. In the case of the content which is to be supplied via on-demand delivery, time entry also indicates that the item becomes available for on-demand delivery as shown using “on-demand” within brackets next to the time. Column 406 includes entries for channel numbers, each entry in column 406 indicates a channel number from which the corresponding content identified in the corresponding row is to be recorded. In the case of the content which is to be supplied via on-demand delivery, the channel number entry is not included as the channel number for on-demand content is not relevant for the purpose of discussion.

Consider row 410 corresponding to content ID 1 and the corresponding first entry of each column. The first entry of column 404 indicates that content corresponding to content ID 1 is scheduled for recording at time T1, while corresponding entry in column 406 indicates that the content is to be recorded is broadcast on channel 15. It should be appreciated that T1, T2, T3, T4 which are simply referred to as time, actually represent both the date and time of the scheduled recording and/or on-demand content availability.

Now consider row 412 corresponding to content ID 2 and the corresponding first entry of each column. The corresponding entry in column 404 indicates that content corresponding to content ID 2 is or will become available for on-demand delivery at time T2. It should be noted that time T2 may, and in some embodiments is, the time earlier than the time at which content identified by content ID 2 is to be aired. For example, content ID 2 may identify a movie which has been previously broadcast and the current broadcast is just a repeat. Thus in such a case, while choosing the on-demand option for delivery for the movie one may think that it will become available only after its broadcast, however in this case the movie becomes available before the time of repeated broadcast since the movie has already been aired once and is available for on-demand delivery from the time of earlier broadcast.

FIG. 5 illustrates an exemplary table 500 illustrating user scheduled recordings. Table 500 which illustrates user scheduled recordings is populated when the user selects some content from, e.g., program guide, for recording or to have the content supplied via on-demand delivery in accordance with the invention. Each of the rows 513 through 518 correspond to a recording event selected by the user, although the selected content may not actually be recorded but rather made available via on-demand delivery.

Each entry in column 502 identifies a channel name and channel number over which the selected content for recording is broadcast. Column 504 includes entries each of which identifies the title of the content, e.g., a movie/program title/name. Each entry in column 506 indicates recording type, that is, whether the corresponding selected content is scheduled for recording on daily basis, weekly basis or just once. Sometimes a user may want to schedule recordings for programs that are broadcast once every week and therefore it will be easier for the user to select weekly recording option for the selected program so that the user does not have to schedule another recording for the next episode of the selected program which will be aired next week.

Each entry in column 508 indicates the recording start time for the corresponding recording event while each entry in column 510 shows the end time for the corresponding recording event. Each entry in column 512 indicates recording date for the corresponding recording event. Various entries and in the table 500 may be populated with corresponding information, e.g., channel number, channel network name, recording start and end times etc., based on the user selection of content from, e.g., a program guide.

Consider the first row 513 and columns 502 through 512. The first recording event in the user scheduled recordings is shown in row 513 which indicates that the user has selected content, i.e., Program A, which is scheduled for broadcast on Fox network-channel number 3 on Nov. 11, 2010, recording type is weekly and recording start time is 8:30 PM and end time is 9:30 PM. It should be noted that Program A is selected for recording on the DVR as there is no indication of any on-demand delivery selection. The second recording event shown in row 514 is what is sometimes referred to as “on-demand recording”. Row 514 indicates that the user has selected content, i.e., Movie 1, which is scheduled for broadcast on HBO network-channel number 5 on Nov. 15, 2010. It should be appreciated that the user has selected on-demand delivery for Movie 1 as indicated by the superscript “OD” next to the movie title. Thus Movie 1 will not be recorded but rather will be available for on-demand delivery and user's list of recordings will be updated to show the availability of Movie 1 for playback as discussed earlier. Similarly, as shown row 518 indicates that selected content, i.e., Game 1, scheduled for broadcast on ESPN-channel number 2 on Nov. 21, 2010 has been selected for on-demand delivery rather than normal recording.

FIG. 6A illustrates an exemplary user list of recordings 600, e.g., a MY RECORDINGS list, in accordance with one embodiment of the invention. The user list of recordings 600 is a list of items which are either recorded by the user or have been chosen by the user for “On-Demand recording” where the content is to be supplied via on-demand delivery instead of having the items recorded and to be recorded in the event the VOD availability time is less than the desired recording retention time. The date and time shown on the top right hand corner in list 600 indicates the current date and time, e.g., date and time on which the user is recording list 600 is being displayed. Each row corresponds to a different content, e.g., a movie, program, event etc., identified by the program/movie title shown by a corresponding entry in column 602. The “OD” superscript appended to some of the program/move titles shown in column 602 indicate that those particular program/movies have been selected for on-demand delivery and are not recorded on the disk. Next, each entry in column 604 specifies the VOD availability time period, i.e., the time interval for which the corresponding content is available for on-demand delivery. For the items which are recorded on the DVR, e.g., Program A, the VOD availability time period entry is not relevant and is therefore not shown. As discussed earlier, the VOD availability time period may be governed by one or more factors including contractual availability time limits. The service provider may not, and in some cases does not, have the rights to distribute and/or make available one or more content items indefinitely.

Column 606 includes information regarding user selected retention time period, i.e., time period for which the user would like a selected content to be available for playback, either the content be on the disk or available via on-demand delivery. Thus each entry in column 606 indicates a user selected retention end time, if the user has chosen any. At the end of the retention time period, the content is removed from the list of recordings 600. If the retention end time has not been selected by the user, then in some embodiments, by default settings, the STB 140 retains the content until the user instructs the STB 140 to deletes the content. Consider the first row 612 in the user's list of recordings. Row 612 indicates that movie “WIZARD OF OZ” is available via on-demand delivery (as may have been chosen by the user earlier) and the VOD availability time is until 11:59 PM-Jun. 1, 2011. As should be noted there is no retention time limit set by the user corresponding to WIZARD OF OZ. Thus in some embodiments “WIZARD OF OZ” will remain available for on-demand delivery to the user at least until 11:59 PM—Jun. 6, 2011.

Consider row 614 which indicates that a movie “AVATAR” is available via on-demand delivery; the VOD availability time is until 12:59 PM—Dec. 30, 2010; and the user would like to retain the movie till Mar. 20, 2011. Note the interesting scenario in this particular case, although the user has selected the movie “AVATAR” to be supplied via on-demand delivery, however the user selected retention time (9:00 PM—Mar. 20, 2011) is beyond the VOD availability time (12:59 PM—Dec. 30, 2010). In such a scenario, in accordance with some embodiments of the invention the STB 140 is configured to download the particular movie “AVATAR” and record it before the VOD availability time period ends. This aspect is highlighted and discussed in detail with regard to FIG. 6B. In some other embodiments the STB 140 determines whether or not the user has played the selected on-demand content at least once, in cases when either the user has not selected a retention time or when the retention time ends after the expiration of the VOD availability period. In such embodiments if the user has not been able to watch the selected on-demand content, the STB 140 downloads and records the on-demand content before the VOD availability time period ends. In still some other embodiments, no such download and record action is taken without an input from user.

Row 616 indicates that “PROGRAM A” is a recorded program and the corresponding user selected retention time is until 11:59 PM—Dec. 31, 2010. Program A is a normal recorded content as evident by the absence of any “OD” indicator. Row 618 indicates that “NFL FINALE” is available via on-demand delivery (as may have been chosen by the user earlier) and the VOD availability time is until 10:00 PM—Jan. 15, 2011. Furthermore there is no user selected retention time for the “NFL FINALE”.

FIG. 6B illustrates an exemplary updated list of user recordings 600′ as displayed to a user on Jan. 1, 2011, e.g., date and time which is subsequent to the date and time (Dec. 28, 2010) to which the FIG. 6A illustration corresponds. Note that the on-demand availability period expired for at least one content item, e.g., AVATAR, between the period occurring between the date corresponding to list 600 and list 600′. Since the retention timer exceeded the VOD availability period, AVATAR was recorded prior to the on-demand availability period expiring so that it would remain available for the remaining portion of the user selected retention time. Note that in FIG. 6B AVATAR is indicated to be a normal recorded program as opposed to being an on-demand program (no “OD” superscript used in list 600′ for AVATAR). Note also that PROGRAM A which had a retention deadline of 11:59 PM—Dec. 31, 2010 has been dropped from the list of recordings since the retention time expired between the date of the FIG. 6A list and the date of the FIG. 6B list. In addition, Program B has been added to the list of recordings since it was recorded during the time period between the FIG. 6A example and the FIG. 6B example. This is shown in row 618′, where it is indicated that PROGRAM B is a normal recorded item (as opposed to on-demand recording) and the user selected retention time is until 10:00 PM Jan. 30, 2011.

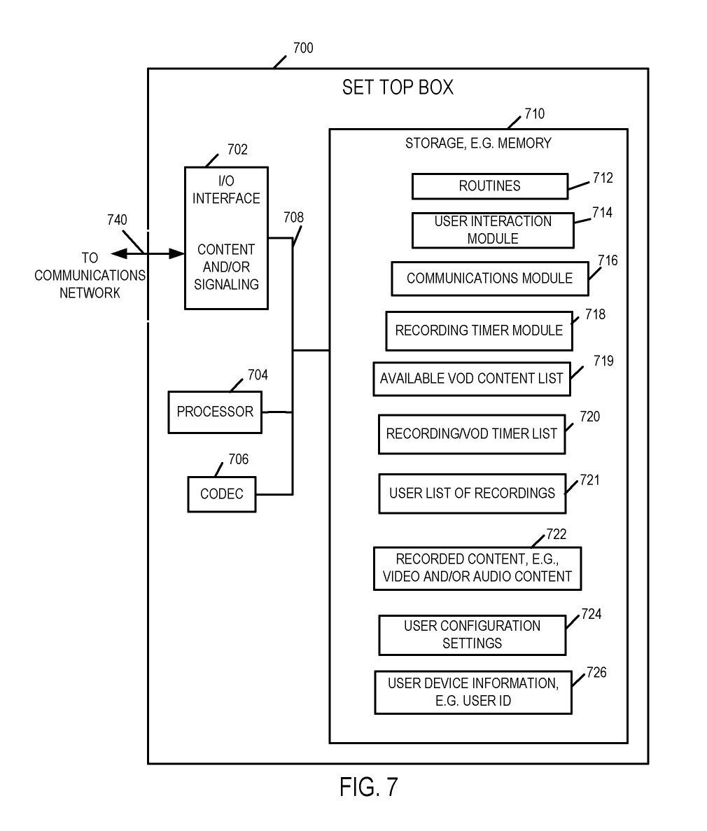

FIG. 7 illustrates an exemplary set top box (STB) 700 implemented in accordance with one exemplary embodiment. The exemplary STB 700 may be used as any one of the STBs 140, 144 of the system shown in FIG. 1. The exemplary STB 700 supports digital video recording operations and includes memory for storing recorded content, various control routines, and a processor which operate as a digital video recording (DVR) device. Thus, in some embodiments a digital video recorder is an integral part of the set top box. In other embodiments, the set top box may be coupled to an external DVR which can be controlled in accordance with the present invention, e.g., by the STB or through a user interface included directly in the DVR.

The STB 700 may be coupled to a display device, e.g. a monitor and/or a Television (TV). The STB 700 includes an Input/Output (I/O) interface 702, a processor 704, a codec (Coder/Decoder) 706, and a storage device, e.g. a memory 710 coupled together via a bus 708. The various elements of the STB 700 can exchange data and information over the bus 708. Via the I/O interface 702, the STB 700 can exchange signals and/or information with other devices such as the VOD server 124 in the network head end 102, via the communications network 176. The I/O interface 702 supports the receipt and/or transmission of content and/or other information from/to different external servers, e.g., the content server 120, VOD server 124 as represented by arrow 740 and may include, in some cases, a cable modem allowing for high speed upload and downloads of data. In addition to supporting the communication of content, I/O interface 702 further supports the communication of application and/or control signals between the set top box 700 and other servers and sub-systems in headend 102 and other external devices. The I/O interface 702 in some embodiments also includes an infrared signal receiver (not shown) to receive signals from a user remote control device, e.g., remote control 143. The I/O interface 702 is configured to receive input commands, e.g., instructions from the user including a request to record selected content.

The processor 704, e.g., a CPU, executes routines 712 stored in the memory 710 and, under direction of the routines 712, controls the STB 700 to operate in accordance with the invention. To control the STB 700, the processor 704 uses information and/or routines including instructions stored in memory 710. The Codec 706 is implemented as a module and is capable of performing encoding and/or decoding operations on a digital data stream or signal.

The memory 710 includes a prompt generation module 714, a communications module 716, a recording timer module 718, a determination module 728, a decision module 730, a recording control module 732, available VOD content list 719, recording/VOD timer list 720, user list of recordings 721, recorded content 722, user configuration settings 724, and user device information 726. Routines 712 include communications routines and/or set top box control routines. The prompt generation module 714 generates and controls presentation of a prompt to the user of the STB 700, providing the user an opportunity to select whether the user would like to have a selected item supplied via on-demand delivery rather than recording the content locally on the DVR. Thus, the prompt generation module 714 prompts the user of STB 700 for input indicating whether the user wants the selected content supplied via an on-demand delivery instead of having the content recorded.

The communications module 716 is used by the STB 700 to set up communications with other external servers and devices. The communications module 716 uses the set of communications routines included in the routines 712 for communicating with the external servers and devices. The communications module 716 controls the I/O interface to send and/or receive information, e.g., messages and control signaling, to and/or from servers in the headend 102 such as the VOD server 124. The communications module 716 is also responsible for setting up on-demand delivery session by setting up communications with the VOD server 124.

The available VOD content list 719 includes the list of available on-demand content and relevant content availability information. The available VOD content list 719 is broadcast from a server, e.g., BFS 120, and is received and stored by the STB 700. The content availability information includes information indicating whether or not one or more content items are available for on-demand delivery and for how long, e.g., a content availability time period corresponding to the content items. In some embodiments the content availability information also indicates a future time at which one or more content items will become available in case if the content items are not currently available. The STB 700 uses the VOD content list 719 to determine whether or not a user selected content is available for on-demand delivery.

The recording timer list 720 includes timing information corresponding to various user requested contents which are either to be recorded or have been selected for supply via on-demand delivery, e.g., upon playback. Timing information corresponding to an item, e.g., content such as a movie, to be recorded indicates the time of its scheduled recording. Timing information corresponding to an item selected to be supplied via on-demand delivery indicates the time that content becomes available for on-demand delivery. The recording/VOD timer list 720 is maintained by the STB 700, and is used in some embodiments to control recording of content and/or for updating the user's list of recorded items 721. The STB 700 uses the recorded/VOD timer list 720 to set the recording timer module 718 which then controls the recording of the user selected content at the scheduled time. An example of a recording/VOD timer list such as list 720 is discussed in the FIG. 4 example.

User list of recordings 721 is a list of items which are either recorded by the user or have been chosen by the user for “On-Demand recording” where the content is to be supplied via on-demand delivery instead of having the items recorded. An exemplary list of recorded items such as list 721 is illustrated in FIGS. 6A and 6B.

Recorded content 722, e.g. video and/or audio data, can be movies, songs, shows etc. that the user has recorded on the set top box 700. It may include content which is being temporarily stored as part of an on-demand content delivery session. In some embodiments the user recorded content 722 is retained for a time period selected by the user and is automatically deleted after the retention time period expires. In some embodiments at least some of the items included in the recorded content 722 are retained as long as the user does not delete such items.

The user configuration settings 724 include the user preferred settings which control how one or more operations are performed by the STB 700. For example the user in some embodiments can configure the settings 724 to control the STB 700 to select the on-demand recording option by default whenever the user selected content is available for on-demand delivery, rather than real recording on the STB 700. Thus in some embodiments the user configured settings 724 indicate whether or not on-demand content delivery should be used in place of recording content selected for recording. In some embodiments the user sets the configuration settings 724 such that the user of STB 700 is presented an option for choosing between on-demand recording and real recording on the STB 700, each time a content item is selected for recording. The user device information 726 may be, e.g. a user ID, Media Access Control (MAC) address of the STB, an IP address assigned to the STB 700, etc. and or other information stored in the set top box memory.

The determination module 728 determines if the user requested content is available for on-demand delivery. The determination module 728 can perform this determination by accessing the available VOD content list 719. In some embodiments the determination module 728 sends a content availability request message to the VOD server 124 and receives a response message including content availability information from the VOD server 124. The determination module 728 then makes the determination based on the received content availability information.

The decision module 730 is used for deciding, when user selected content is available for on-demand delivery, whether the content is to be supplied via-on demand delivery or recorded. The decision module 730 is configured to make such a decision based on a user input. In some embodiments the user input is one of: i) a default setting included in user configuration settings 724 and ii) a response to a prompt, e.g., response to a prompt presented to the user requesting the user for input indicating whether the user wants the selected content supplied via an on-demand delivery instead of having the content recorded.

The recording control module 732 is for controlling the STB 700 to record user selected content when said content is not available for on-demand delivery or when the decision module 730 decides that content available for on-demand delivery is to be recorded.

In accordance with one embodiment, an exemplary method of handling a request to record content from a user, comprises: determining if said content is available for on-demand delivery; if it is determined that said video content is available for on-demand delivery, determining, based on a user input, whether the content is to be supplied via-on-demand delivery or recorded; and if said content is determined not to be available for on-demand delivery, controlling a recording device to record said content. In some embodiments the user input is one of: i) a default setting by the user and ii) a response to a prompt.

In some embodiments, when it is determined that said video content is available for on-demand delivery, the method further comprises prompting said user for input indicating whether the user wants the content supplied via an on-demand delivery instead of having the content recorded.

In some embodiments the recording device is a digital video recorder located at a customer premise corresponding to said user; and controlling a recording device to record said content includes setting a recording timer on said digital video recorder.

In some embodiments the digital video recorder is included in a set top box, e.g., STB 700, and the set top box performs the step of determining if said content is available for on-demand delivery. In some embodiments determining if said content is available for on-demand delivery includes accessing a list of video on-demand content, e.g., VOD content availability list 132, to determine if said content is currently available. In some embodiments the list of video on-demand content is a list stored in a customer premise device including said digital video recording device. In some embodiments said list is a broadcast list received from a server.

In some embodiments determining if said content is available for on-demand delivery further includes: determining when the content may be delivered to the user; and determining that said content to be recorded is available for on-demand delivery when said content is not currently available for delivery but will be available before or at the time said content is to be recorded.

In some embodiments determining if said content is available for on-demand delivery includes: sending a message, e.g., request message 254, requesting content availability information to a device located outside said customer premise; and receiving a response message, e.g., message 256, indicating whether or not said content is available for on-demand delivery. In some embodiments the message requesting content availability information includes information identifying said content (e.g., movie title, program title & episode number, or scheduled presentation time & channel number). In some embodiments the response message indicates a time at which the content can be accessed when said response message indicates that the content is available but it is not immediately available for delivery (e.g., the initial presentation time of a program may be the earliest time the content is available for on-demand delivery).

In some embodiments a global preference can be set by the user on the user's digital video recording device which can interact with the service provider system such as the headend 102 including the VOD server 124, where the user can select to prefer to access content over VOD instead of recording it locally where deferring the local recording is dependent upon the number of days that the video content will remain on the VOD platform, i.e., will remain available for on-demand delivery. In other words, the user can set a preference that will cause the local video to be deferred as long as the content will persist on the VOD platform for a minimum of, e.g., 3 days, 5 days, 2 months, etc.

In some embodiments the user interface that the subscriber uses to record a video is either via a grid guide or by choosing to record a program on a channel to which the user is currently tuned. In either case, if the user has chosen to prefer watching from the VOD platform, when the user indicates that a program is to be recorded, the user will receive a message on-screen indicating that the program is available on the VOD platform. The message also indicates to the user information about whether the content is available on the VOD platform but not within the user's preferred retention period, or is available and contains an indicator about how long the video will remain available. For example, the indicator may say “Program available until Dec. 21, 2010”, or it could say “Program available on VOD for 2 more days—watch it now”, or “Program will disappear soon”, etc. The user interface in some embodiments allows the subscribers to over-ride their preferences. For example, if a user prefers to only defer recordings to the VOD platform if content is retained for 2 months, they can still defer a recording to the VOD platform if it is available only for another 3 days if they feel confident that they will watch the program within that time period.

While described in the context of a video on-demand system, it should be appreciated that the methods and apparatus of the present invention are not limited to the delivery of video content and can be used to support delivery of audio content and/or other types of information content which may be requested by a CP (customer premise) device.

In various embodiments system elements described herein are implemented using one or more modules which are used to perform the steps corresponding to one or more methods of the present invention, for example, presenting the user with available content information, receiving a user input indicating a request to record content, determining if the requested content is available for on-demand delivery, determining whether the requested content is to be supplied via-on demand delivery or recorded, prompting the user for input indicating whether the user wants the content supplied via an on-demand delivery instead of having the content recorded, etc. Each step may be performed by one or more different software instructions executed by a computer processor, e.g., a central processing unit (CPU).

At least one system implemented in accordance with the present invention includes a means for implementing each of the various steps which are part of the methods of the present invention. Each means may be, e.g., an instruction, processor, hardware circuit and/or combination of elements used to implement a described step.

Many of the above described methods or method steps can be implemented using machine, e.g., computer, executable instructions, such as software, included in a machine, e.g., computer, readable medium used to control a machine, e.g., general purpose computer with or without additional hardware, to implement all or portions of the above described methods, e.g., in one or more nodes. The machine readable medium may be, e.g., a memory device, e.g., RAM, floppy disk, etc. Accordingly, among other things, the present invention is directed to a non-transitory machine, e.g., computer, readable medium including machine executable instructions for causing a machine, e.g., processor and associated hardware, to perform one or more of the steps of the above-described method(s).

Numerous additional embodiments, within the scope of the present invention, will be apparent to those of ordinary skill in the art in view of the above description and the claims which follow.

What is claimed is:

1. A method of handling a request to record content from a user, the method comprising:
determining if said content is available for on-demand delivery;
if it is determined that said video content is available for on-demand delivery, determining whether the content is to be supplied via on-demand delivery or recorded; and
if said content is determined not to be available for on-demand delivery, controlling a recording device to record said content.

2. The method of claim 1, wherein determining whether the content is to be supplied via-on demand delivery is made based on user input, said user input being one of: i) a default setting by the user or ii) a response to a prompt.

3. The method of claim 1, further comprising:
when it is determined that said video content is available for on-demand delivery, prompting said user for input indicating whether the user wants the content supplied via an on-demand delivery instead of having the content recorded.

4. The method of claim 1,
wherein said recording device is a digital video recorder located at a customer premise corresponding to said user; and
wherein controlling a recording device to record said content includes setting a recording timer on said digital video recorder.

5. The method of claim 4,
wherein said digital video recorder is included in a set top box; and
wherein said set top box performs said step of determining if said content is available for on-demand delivery.

6. The method of claim 1, wherein determining if said content is available for on demand delivery includes:
accessing a list of video on-demand content to determine if said content is currently available.

7. The method of claim 6, wherein determining if said content is available for on-demand delivery further includes:
determining when the content may be delivered to the user; and
determining that said content to be recorded is available for on-demand delivery when said content is not currently available for delivery but will be available before or at the time said content is to be recorded.

8. The method of claim 6, wherein said list is a list stored in a customer premise device including said digital video recording device.

9. The method of claim 8, wherein said list is a broadcast list received from a server.

10. The method of claim 4, wherein determining if said content is available for on-demand delivery includes:
sending a message requesting content availability information to a device located outside said customer premise; and
receiving a response message indicating whether or not said content is available for on-demand delivery.

11. The method of claim 10, wherein said response message indicates a time at which the content can be accessed when said response message indicates that the content is available but it is not immediately available for delivery.

12. A recording device comprising:
an interface for receiving a request to record content;
an on-demand determination module for determining if said content is available for on-demand delivery;
a decision module for deciding, when content is available for on-demand delivery, whether the content is to be supplied via-on demand delivery or recorded; and
a recording control module for controlling said recording device to record content when said content is not available for on-demand delivery or when said decision module decides that content available for on-demand delivery is to be recorded.

13. The recording device of claim 12, wherein said request to record content is a request to record linear broadcast content

14. The recording device of claim 12, further comprising:
a network interface configured to signal a remote storage device to provide said requested content when the availability of said requested content via on-demand delivery is about to expire.

15. The recording device of claim 14, wherein said remote storage device is a HTTP sever with access to said requested content.

16. The recording device of claim 12, further comprising:
memory for storing a default setting by the user indicating whether or not on-demand delivery should be used in place of recording content selected for recording.

17. The recording device of claim 12, further comprising:
a prompt generation module for prompting said user for input indicating whether the user wants the content supplied via an on-demand delivery instead of having the content recorded.

18. The method of claim 12,
wherein said recording device is an integral part of a set top box.

19. A recording device comprising:
means for receiving a request to record content;
means for determining if said content is available for on-demand delivery;
means for deciding, when content is available for on-demand delivery, whether the content is to be supplied via-on demand delivery or recorded; and
means for controlling said recording device to record content when said content is not available for on-demand delivery or when said means for deciding decides that content available for on-demand delivery is to be recorded.

20. The recording device of claim 19, further comprising:
means for storing a default setting by the user indicating whether or not on-demand delivery should be used in place of recording content selected for recording.
